(19) United States
(12) Patent Application Publication
(10) Pub. No.: US 2025/0291455 A1
(43) Pub. Date: Sep. 18, 2025

(54) INTERACTIVE CONTROL APPARATUS AND INTERACTIVE SYSTEM

(71) Applicant: SHENZHEN HONGJIANTOU TECHNOLOGY CO, LTD, Shenzhen (CN)

(72) Inventor: Zhinan Zhang, Shenzhen (CN)

(21) Appl. No.: 19/075,913

(22) Filed: Mar. 11, 2025

(30) Foreign Application Priority Data
Mar. 14, 2024 (CN) 202410291584.6
Mar. 14, 2024 (CN) 202420494942.9

(51) Int. Cl. G06F 3/04815; G01S 17/06

(52) U.S. Cl. CPC G06F 3/04815; G01S 17/06

(57) ABSTRACT

The present invention relates to the technical field of computers, and discloses an interactive control apparatus and an interactive system. The interactive control apparatus comprises a housing and an interactive control module arranged in the housing; the interactive control apparatus is independently attached to an interactive device through the housing, and the interactive control apparatus is communicatively connected with an extended reality device through the interactive control module; and the interactive control module is used for processing input instructions executed by users on the interactive device and controlling the extended reality device according to processing results to display the corresponding virtual interactive interface. The technical solution of the present application can improve the immersive experience of users.

### CROSS REFERENCE TO RELATED APPLICATIONS

The present application claims the benefit of Chinese Patent Application Nos. 202410291584.6 and 202420494942.9 filed on Mar. 14, 2024, the contents of which are incorporated herein by reference in their entirety.

### FIELD OF INVENTION

The present invention relates to the technical field of computers, and particularly relates to an interactive control apparatus and an interactive system.

### BACKGROUND ART OF THE INVENTION

The Extended Reality (XR) technology refers to the combination of the real world and the virtual world through computers to create a human-computer interactive virtual environment, which is also a general term for various technologies such as Augmented Reality (AR), Virtual Reality (VR) and Mixed Reality (MR). The integration of the three visual interaction technologies brings experiencers the immersion of seamless transition between the virtual world and the real world.

Most of the current XR devices (such as XR Glass) are provided with a control handle, which is equivalent to the mouse and keyboard of a PC and the touch screen of a smart phone. Moreover, the control handle is usually provided with modules such as an attitude sensor, an MCU, a locating sensor, a button and a joystick to enhance the interaction between users and the virtual world through the modules. However, at present, the control handle cannot cover the functions required by all XR applications (such as leg movement games) and has limited functions. In addition, the control handle cannot be used perfectly in special scenarios (such as shooting games, badmintons or golfs) due to the limited shape thereof, thus lacking enough immersion.

### DISCLOSURE OF THE INVENTION

In view of the above problems, embodiments of the present invention provide an interactive control apparatus and an interactive system, which are used for solving the problem in the prior art that the functions of the control handle are limited in special occasions.

According to one aspect of the embodiments of the present invention, an interactive control apparatus is provided, comprising a housing and an interactive control module arranged in the housing;

The interactive control apparatus is independently attached to an interactive device through the housing, and the interactive control apparatus is communicatively connected with an extended reality device through the interactive control module;

The interactive control module is used for processing input instructions executed by users on the interactive device and controlling the extended reality device according to processing results to display the corresponding virtual interactive interface.

The interactive control apparatus is in wireless communication with one end of the extended reality device by being physically attached to the interactive device independently and by means of wireless communication connection, which is equivalent to modularizing the functions of the original control handle and applying the control handle to different interactive devices, thereby increasing application scenarios and enriching user experience. While in use, users only need to load the interactive control apparatus in the present application on the interactive device and then perform corresponding operation on the interactive device, and the interactive control apparatus will process the data and display the corresponding virtual interactive interface on the extended reality device according to the processing results.

In an optional mode, the interactive control module is also used for controlling the interactive device according to the processing results to generate real interactive feedback.

In an optional mode, the housing is provided with clips and/or adhesive backing and/or magnetic strips; and the housing is attached to the interactive device through the clips and/or adhesive backing and/or magnetic strips.

In an optional mode, the interactive control module comprises an input/output interface, a wireless communication module and an MCU;

The MCU is connected with the extended reality device through the wireless communication module, the MCU is connected with the interactive device through the input/output interface, and the MCU realizes data transmission with the interactive device through the input/output interface.

In an optional mode, the wireless communication module comprises any one of a Bluetooth module, a Zigbee module and a WiFi module.

In an optional mode, the interactive control apparatus also comprises:

A locating module, connected with the interactive control module and configured to locate attitude and position of the interactive device.

In an optional mode, the locating module comprises an infrared sensor and an inertial measurement unit; and the infrared sensor is used for locating the position of the interactive device, and the inertial measurement unit is used for locating the attitude of the interactive device.

In an optional mode, the inertial measurement unit comprises a tri-axial accelerometer and a tri-axial gyroscope.

In an optional mode, the interactive control apparatus also comprises:

A power interface, electrically connected with the MCU and configured to provide a charging port for the MCU.

In an optional mode, the interactive control apparatus also comprises:

A power supply module, electrically connected with the MCU and used for providing electrical energy for the MCU.

According to another aspect of the embodiments of the present invention, an interactive system is provided, comprising at least one interactive control apparatus of any one of the above embodiments, at least one interactive device and at least one extended reality device, wherein one interactive control apparatus is independently attached to one interactive device correspondingly; and one extended reality device is connected with at least one interactive control apparatus.

In an optional mode, the interactive system comprises two interactive control apparatuses, two interactive devices and one extended reality devices; and the two interactive control apparatuses are communicatively connected with the extended reality device respectively, and the two interactive control apparatuses are independently attached to the two interactive devices respectively.

In an optional mode, the interactive device comprises any one of an electron gun, a dance pad, a golf club, a tennis racket, a badminton racket and an exercise bike.

In an optional mode, the extended reality device comprises an augmented reality device, a virtual reality device or a mixed reality device.

In an optional mode, the interactive device is an electron gun, and the electron gun comprises an electron gun body, a chambering module, a heart rate sensor, a loading module, a vibrating motor and a firing button.

The above illustration is only an overview of the technical solution of embodiments of the present invention. To understand the technical means of the embodiments of the present invention more clearly, the technical solution can be implemented in accordance with contents of the description, and to make above and other purposes, features and advantages of the present invention more apparent and legible, specific embodiments of the present invention are provided below.

### DESCRIPTION OF THE DRAWINGS

To more clearly describe the technical solutions in the embodiments of the present invention or in the prior art, the drawings required to be used in the description of the embodiments or the prior art will be simply presented below. Obviously, the drawings in the following description are merely some embodiments of the present invention, and for those ordinary skilled in the art, other drawings can also be obtained according to structures shown in the drawings without contributing creative labor.

FIG. 1 is a modular schematic diagram containing an interactive control apparatus in one embodiment of the present application;

FIG. 2 is a local amplified modular schematic diagram of an interactive control apparatus in FIG. 1;

FIG. 3 is a modular schematic diagram of an interactive device in one embodiment of the present application;

FIG. 4 is a modular schematic diagram of an interactive system in one embodiment of the present application.

### REFERENCE SIGNS

10—interactive device; 10a—electron gun; 10b—dance pad; 20—interactive control apparatus; 20a—first interactive control apparatus; 20b—second interactive control apparatus; 30—extended reality device; 220—interactive control module; 2202—input/output interface; 2204—MCU; 2206—wireless communication module; 224—locating module; 226—power interface; 228—power supply module; 110—interactive device body; 120—chambering module; 130—heart rate sensor; 140—loading module; 150—vibrating motor; 160—firing button.

Realization of the purpose, functional characteristics and advantages of the present invention will be further described in combination with the embodiments and with reference to the drawings.

### DETAILED DESCRIPTION OF THE INVENTION

The technical solutions in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

It should be noted that if the embodiments of the present invention involve directional indications (such as upper, lower, left, right, front, back and the like), the directional indications are only used to explain the relative position relationship and movement conditions of components under a specific attitude (as shown in the drawings). If the specific attitude is changed, the directional indications are changed accordingly.

In addition, if the embodiments of the present invention involve the description of “first” and “second”, the description of “first” and “second” is only used for the purpose of description, rather than being understood to indicate or imply relative importance or hint the number of indicated technical features. Thus, the features limited by “first” and “second” can explicitly or impliedly comprise at least one feature. In addition, if “and/or” in the full text means including three parallel solutions, “A and/or B”, for example, includes a solution A, or a solution B, or a solution satisfying A and B simultaneously. In addition, the technical solutions in the embodiments can be combined with each other, but only on the basis that the combination can be implemented by those ordinary skilled in the art. Where a combination of technical solutions is contradictory or impossible to be implemented, it shall be deemed that such combination of technical solutions does not exist and is not included within the protection scope of the present invention.

As described in the background art of the present application, most of the current XR devices (such as XR Glass) are provided with a control handle, which is equivalent to the mouse and keyboard of a PC and the touch screen of a smart phone. Moreover, the control handle is usually provided with modules such as an attitude sensor, an MCU, a locating sensor, a button and a joystick to enhance the interaction between users and the virtual world through the modules. However, at present, the control handle cannot cover the functions required by all XR applications (such as leg movement games) and has limited functions. In addition, the control handle cannot be used perfectly in special scenarios (such as shooting games, badmintons or golfs) due to the limited shape thereof, and lacks enough immersion.

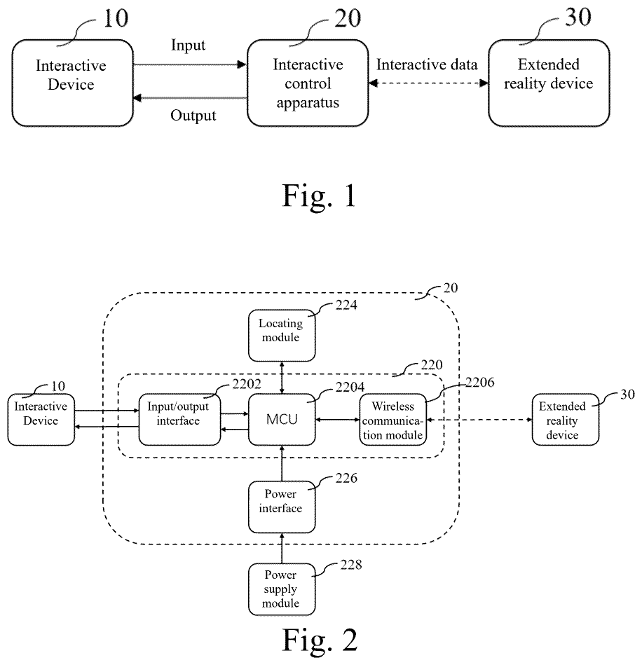

Therefore, the present application provides a new interactive control apparatus, as shown in FIG. 1 and FIG. 2. The interactive control apparatus 20 can comprise a housing (not shown in the figures) and an interactive control module 220 arranged in the housing; the interactive control apparatus 20 is independently attached to an interactive device 10 through the housing, and the interactive control apparatus 20 is communicatively connected with an extended reality device 30 through the interactive control module 220; and the interactive control module 220 is used for processing input instructions executed by users on the interactive device 10 and controlling the extended reality device 30 according to processing results to display the corresponding virtual interactive interface.

The interactive control apparatus is in wireless communication with one end of the extended reality device by being physically attached to the interactive device independently and by means of wireless communication connection, which is equivalent to modularizing the functions of the original control handle and applying the control handle to different interactive devices, thereby increasing application scenarios and enriching user experience. While in use, users only need to load the interactive control apparatus in the present application on the interactive device and then perform corresponding operation on the interactive device, and the interactive control apparatus will process the data and display the corresponding virtual interactive interface on the extended reality device according to the processing results.

The above illustration is only an overview of the technical solution of embodiments of the present invention. To understand the technical means of the embodiments of the present invention more clearly, the technical solution can be implemented in accordance with contents of the description, and to make above and other purposes, features and advantages of the present invention more apparent and legible, specific embodiments of the present invention are provided below.

In the present specific embodiment, to facilitate the independent attachment of the interactive control apparatus 20 to the interactive device 10, the housing of the interactive control apparatus 20 is provided with clips and/or adhesive backing and/or magnetic strips in the present application. It can be understood that the housing can be provided with only clips or adhesive backing or magnetic strips, or clips and adhesive backing, or clips and magnetic strips, or adhesive backing and/or magnetic strips. In other embodiments, the housing can also be provided with clips, adhesive backing and magnetic strips. With the increase of the attachment modes, the connection between the housing and the interactive device 10 can be more stable, preventing the interactive control apparatus 20 from being thrown out or disengaged when users use the interactive device 10 and improving user experience.

In the present specific embodiment, the interactive control module 20 can only be required to process the data transmitted by the interactive device 10, and then control the extended reality device 30 to display the corresponding virtual interactive interface. In other embodiments, the interactive control module 20 can also control the interactive device 10 to generate real interactive feedback in some special application scenarios in addition to data processing. The interactive control module 20 can be expanded to have multiple functions through the arranged input/output interface 2202, and then buttons corresponding to the expanded functions are installed on specific interactive devices to realize the adaptation of different types of interactive devices 10.

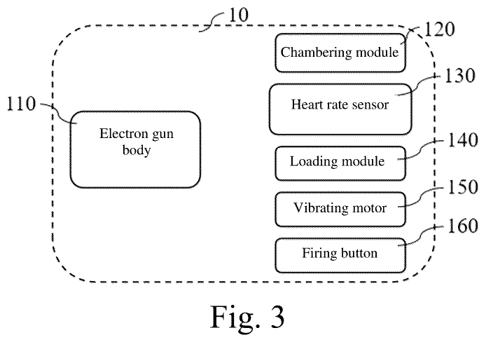

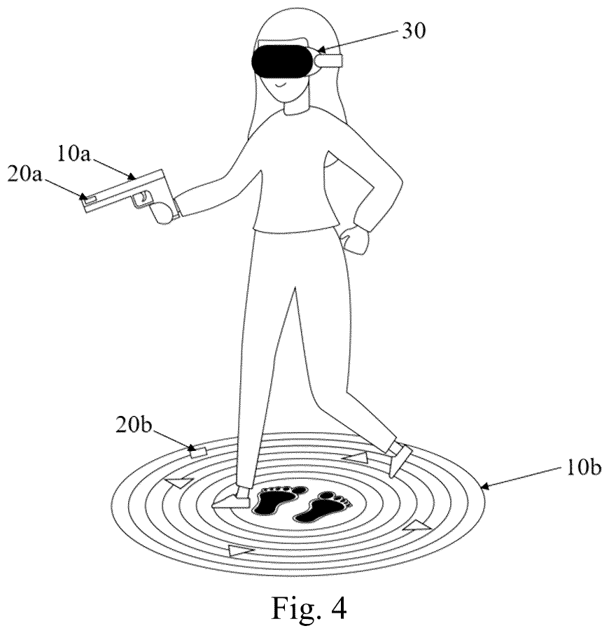

Referring to FIG. 3 and FIG. 4, the interactive device 10 can be a device with electronic functions and extended connectivity functions, such as an electron gun 10a or a dance pad 10b. It can be understood that the interactive device 10 can also be a golf club, a tennis racket, an exercise bike or other fitness equipment.

As shown in FIG. 3, when the interactive device 10 is an electron gun, the electron gun 10a can comprise an electron gun body 110, a chambering module 120, a heart rate sensor 130, a loading module 140, a vibrating motor 150 and a firing button 160. Accordingly, the sensors and the modules realize data transmission with the interactive control apparatus through the input/output interface 2202 (USB-C). The electron gun body 110 is a mechanical structure made following the shape of a gun, and the chambering module 120 and the loading module 140 give the electron gun 10a functions similar to a real gun. Meanwhile, as an extension, the heart rate sensor 130, the vibrating motor 150 and the firing button 160 are extended through the input/output interface 2202 and used with the extended display device 30 to improve the immersive experience of users. It can be understood that the above comprising the chambering module 120, the heart rate sensor 130, the loading module 140, the vibrating motor 150 and the firing button 160 is a mechanical structure or electron component currently available directly, and the details of the components are not further described in the present application, which shall be subject to selection and adjustment made by those skilled in the art according to actual situations.

As shown in FIG. 4, when the interactive device 10 is a dance pad 10b, the dance pad 10b is provided with one sole sensing area and four direction sensing areas (forward, backward, leftward and rightward). Meanwhile, gravity sensors or membrane switches or capacitive contact materials are arranged in the sensing areas, so that users can generate corresponding data when moving in all directions on the dance pad 10b, and the data can also be transmitted to the interactive control apparatus 20 through an expansion interface (USB-C).

The interactive control apparatus 20 has a function of data processing, that is, the interactive control apparatus 20 can process the data, and after the processing is completed, the extended reality device 30 can be controlled to display the corresponding virtual interactive interface. Further, to enrich the interactive experiences of users, the interactive control apparatus 20 can further control the interactive device 10 according to the processing results to generate real interactive feedback. For example, when the interactive device 10 is an electron gun 10a, a user holds the electron gun 10a and takes the actions of chambering and firing. At this time, the interactive control apparatus 20 will trigger the vibrating motor 150 of the electron gun 10a to achieve the effect similar to recoil. At the same time, the interactive control apparatus 20 will transmit the data to the extended reality device 30 in a wireless manner, and the extended reality device 30 will reflect the virtual effect (picture and sound) of the operation of the above user. The interactive mode of the dance pad 10b is similar to that of the electron gun 10a, except that the dance pad 10b cannot provide recoil feedback unique to the electron gun 10a. It can be understood that when the interactive device 10 is other electron device, the corresponding interactive and connection modes are similar to those of the electron gun 10a and the dance pad 10b, which is not further described in the present application. The interactive device 10 is not limited to the electron gun 10a and the dance pad 10b, which can be selected and adjusted by those skilled in the art according to actual products and needs.

Further, the extended reality device 30 of the present application can be an augmented reality device, a virtual reality device or a mixed reality device. Meanwhile, the extended reality device 30 can be embodied through glasses, a head mounted display and so on.

In the present specific embodiment, the interactive control apparatus 20 extracts part of the functions (data processing, data connection and communication connection) of the original control handle in fact and is attached to any interactive device 10 in combination with a physical connection structure. The present application does not involve improvements to methods or algorithms, and the functions (data processing, data connection and communication connection) can be realized by the prior art or by reference to the functions of the control handle.

In other embodiments, to ensure that the interactive control apparatus 20 of the present application can realize the above functions, the interactive control module 220 in the present specific embodiment can comprise an input/output interface 2202, a wireless communication module 2206 and an MCU 2204.

The MCU 2204 is connected with the interactive device 10 through the input/output interface 2202, the MCU 2204 is connected with the extended reality device 30 through the wireless communication module 2206, and the MCU 2204 realizes data transmission with the interactive device 10 through the input/output interface 2202. Further, the wireless communication module 2206 can comprise any one of a Bluetooth module, a Zigbee module and a WiFi module. The MCU 2204 can be any integrated chip with data processing, which is not further defined in the present application. The input/output interface 2202 can be a USB-C interface or other interface with a data transmission capability known by those skilled in the art.

Referring to FIG. 2, the interactive control apparatus 20 of the present application can also comprise:

A locating module 224, connected with the interactive control module 220 and configured to locate attitude and position of the interactive device 10. Specifically, the locating module 224 can comprise an infrared sensor (not shown in the figure) and an inertial measurement unit (not shown in the figure); and the infrared sensor is used for locating the position of the interactive device 10, and the inertial measurement unit is used for locating the attitude of the interactive device 10. Further, the inertial measurement unit can realize six degrees of freedom, and to realize six degrees of freedom, the inertial measurement unit can comprise a tri-axial accelerometer and a tri-axial gyroscope. It can be understood that the specific functions of the locating module 224, the inertial measurement unit and the infrared sensor in the present specific embodiment can be realized by reference to the control handle of the existing XR device, and the present application only extracts and integrates the existing functions into the interactive control apparatus 20, which is not further described in the present application.

To realize power supply to the interactive control apparatus 20, the interactive control apparatus 20 of the present application can also comprise: a power interface 226, which is electrically connected with the MCU 2204 and configured to provide a charging port for the MCU 2204 so that the MCU 2204 can be charged by an alive interactive device 10 or other power supply facilities, and the power interface 226 can also be integrated with the MCU 2204. The other modules of the interactive control module 220 can be powered by the MCU 2204, and the power interface 226 can be a USB interface, a USB-C interface or a DC/DC interface. In addition, since the USB-C interface has the functions of data transmission and current transmission, the power interface 226 and the input/output interface 2202 in the present specific embodiment can also be integrated as a whole, which is realized through functions similar to those of USB-C, and the power interface 226 can also be arranged in the housing.

Optionally, a power supply module 228 can also be arranged, the power supply module 228 can be placed in the housing or can be independent, and the power supply module 228 is used for providing electrical energy for the MCU 2204. The power supply module 228 has charge/discharge capabilities, which can omit power connection lines between the interactive control apparatus 20 and the interactive device 10 or other power supply facilities. In the present embodiment, the interactive device 10 is not required to have an electrical function, that is, in this case, the interactive device 10 can have a purely mechanical structure, for example, a tennis racket, a golf club and so on.

The embodiments of the present invention modularize part of the functions of the control handle of the original XR device, and then the modularized part is attached to any interactive device to provide users with physical objects, which can greatly improve the interactive experience and immersion of users and bring effects that the original control handle cannot bring to users.

Referring to FIG. 3, according to another aspect of the embodiments of the present invention, an interactive system is also provided, comprising at least one interactive control apparatus 20 of any one of the above embodiments, at least one interactive device 10 and at least one extended reality device 30, wherein one interactive control apparatus 20 is correspondingly attached to one interactive device 10; and one extended reality device 30 is connected with at least one interactive control apparatus 20.

The present application modularizes part of the functions of the control handle of the original XR device, then the modularized part is attached to any interactive device, and at the same time, a plurality of interactive devices with interactive control apparatuses can also collaborate, which can greatly improve the interactive experience and immersion of users and bring effects that the original single control handle cannot bring to users.

Further, in an optional mode, the interactive device 10 can be any one of an electron gun, a dance pad, a golf club, a tennis racket, a badminton racket and an exercise bike. FIG. 4 shows the case where the interactive device 10 is an electron gun 10a or a dance pad 10b. The electron gun 10a is provided with a vibrating motor 150. The extended reality device 30 comprises an augmented reality device, a virtual reality device or a mixed reality device. Taking FIG. 4 as an example, the electron gun 10a and the dance pad 10b are provided with a first interactive control apparatus 20a and a second interactive control apparatus 20b respectively, and the first interactive control apparatus 20a and the second interactive control apparatus 20b are communicatively connected with the extended reality device 30 respectively. In this application scenario, a user can play some gunfight games, and the user can hold the electron gun 10a, wear the extended reality device 30 on the head and step on the dance pad 10b so that the operation performed by the user on the electron gun 10a and the dance pad 10b will be synchronized to the extended reality device 30, which greatly improves the usage experience and immersion of the user. It can be understood that in other embodiments, a plurality of extended reality devices 30 can also be connected collaboratively so that different users can play the same game. For example, a user 1 uses one interactive system (an electron gun 10a, a dance pad 10b and an extended reality device 30), a user 2 uses one interactive system (an electron gun 10a, a dance pad 10b and an extended reality device 30), and the two users play the same game at the same time. The extended reality device 30 of the user 1 is communicatively connected with the extended reality device 30 of the user 2 to realize data synchronization. When virtual information is displayed, the extended reality device 30 of the user 1 displays information about the current game interface, the electron gun 10a, the dance pad 10b and the user 2. Similarly, the extended reality device 30 of the user 2 displays information about the current game interface, the electron gun 10a, the dance pad 10b and the user 1. In this way, the application scenarios of the interactive system of the present application can be increased to improve the collaborative play experience of multiple users.

To understand the technical means of the embodiments of the present invention more clearly, the technical solution can be implemented in accordance with contents of the description, and to make above and other purposes, features and advantages of the present invention more apparent and legible, specific embodiments of the present invention are provided below.

I. Interaction of a user with the electron gun 10a when using the electron gun 10a to play an XR shooting game:
1. Firstly, the interactive control apparatus 20 is fixed to the surface or interior of the electron gun 10a through magnetic strips and/or adhesive backing and/or clips; and the electron gun 10a has mechanical structures for loading, chambering and triggering;
2. A Bluetooth connection between the interactive control apparatus 20 and the extended reality device 30 is established for subsequent communication;
3. The interactive control apparatus 20 is located through the locating module 224 to interact with the extended reality device, and the interface of the extended reality device obtains the position and status of the electron gun 10a;
4. The user triggers the corresponding mechanical structure of the electron gun 10a when using the electron gun 10a, and the trigger instructions are transmitted to the interactive control apparatus 20 through the input/output interface 2202;
5. The MCU 2204 of the interactive control apparatus 20 processes the data, and the data is fed back to the vibrating motor 150 of the electron gun 10a to produce a recoil effect after firing;
6. The data of the interactive control apparatus 20 is fed back to the interface of the extended reality device 30 via Bluetooth to generate interaction.

II. Interaction of a user with the dance pad 10b when using the dance pad 10b to play games requiring marching such as a sports game or a shooting game:

In traditional XR games, the user moves forward, backward, leftward and rightward through manual operation of a joystick, which is far from the real leg walking experience. The interactive control apparatus 20 is integrated on the dance pad 10b so that the dance pad 10b can replace the joystick function of the XR handle.
1. Firstly, the interactive control apparatus 20 is fixed to the surface or interior of the dance pad 10b through magnetic strips and/or adhesive backing and/or clips;
2. A Bluetooth connection between the interactive control apparatus 20 and the extended reality device 30 is established for subsequent communication;
3. The interactive control apparatus 20 is located through the locating module 224 to interact with the extended reality device 30, and the interface of the extended reality device 30 obtains the position and status of the dance pad 10b;
4. Gravity sensors or membrane switches or capacitive contact materials are arranged in all directions of the dance pad 10b, and the data generated by the user when moving in all directions of the dance pad 10b is transmitted to the interactive control apparatus 20;
5. The MCU 2204 of the interactive control apparatus 2204 processes the data, and the data is fed back to the display interface of the extended reality device 30 via Bluetooth to generate interaction.

III. Interaction of a user when using the electron gun 10a and the dance pad 10b to play a shooting game:
1. Firstly, the first interactive control apparatus 20a and the second interactive control apparatus 20b are fixed on the electron gun 10a and the dance pad 10b respectively;
2. A Bluetooth connection between the first interactive control apparatus 20a and the interactive control apparatus 20b and the extended reality device 30 is established;
3. The first interactive control apparatus 20a and the second interactive control apparatus 20b locate the current positions and statuses of the electron gun 10a and the dance pad 10b through the respective locating modules and feed back the positions and statuses to interact with the extended reality device 30;
4. The user performs corresponding operation (firing and marching) on the electron gun 10a and the dance pad 10b respectively, and the data is processed by the first interactive control apparatus 20a and the second interactive control apparatus 20b respectively and then fed back to the display interface of the extended reality device 30 via Bluetooth to generate interaction.

The above only describes optional embodiments of the present invention, but is not intended to limit the patent scope of the present invention. Under the conception of the present invention, any equivalent structure transformation made by using contents of the description and drawings of the present invention, or directly/indirectly used in other relevant technical fields shall be similarly contained within the protection scope of patent of the present invention.

What is claimed is:

1. An interactive control apparatus, characterized by comprising a housing and an interactive control module arranged in the housing;
the interactive control apparatus is independently attached to an interactive device through the housing, and the interactive control apparatus is communicatively connected with an extended reality device through the interactive control module;
the interactive control module is used for processing input instructions executed by users on the interactive device and controlling the extended reality device according to processing results to display the corresponding virtual interactive interface.

2. The interactive control apparatus as claimed in claim 1, characterized in that: the interactive control module is also used for controlling the interactive device according to the processing results to generate real interactive feedback.

3. The interactive control apparatus as claimed in claim 1, characterized in that: the housing is provided with clips and/or adhesive backing and/or magnetic strips; and the housing is attached to the interactive device through the clips and/or adhesive backing and/or magnetic strips.

4. The interactive control apparatus as claimed in claim 1, characterized in that: the interactive control module comprises an input/output interface, a wireless communication module and an MCU;
the MCU is connected with the extended reality device through the wireless communication module, the MCU is connected with the interactive device through the input/output interface, and the MCU realizes data transmission with the interactive device through the input/output interface.

5. The interactive control apparatus as claimed in claim 4, characterized in that: the wireless communication module comprises any one of a Bluetooth module, a Zigbee module and a WiFi module.

6. The interactive control apparatus as claimed in claim 4, characterized by also comprising:
a locating module, connected with the interactive control module and configured to locate attitude and position of the interactive device.

7. The interactive control apparatus as claimed in claim 6, characterized in that: the locating module comprises an infrared sensor and an inertial measurement unit; and the infrared sensor is used for locating the position of the interactive device, and the inertial measurement unit is used for locating the attitude of the interactive device.

8. The interactive control apparatus as claimed in claim 4, characterized by also comprising:
a power interface, electrically connected with the MCU and configured to provide a charging port for the MCU.

9. The interactive control apparatus as claimed in claim 4, characterized by also comprising:
a power supply module, electrically connected with the MCU and used for providing electrical energy for the MCU.

10. An interactive system, characterized by comprising at least one interactive control apparatus of claim 1, at least one interactive device and at least one extended reality device, wherein the interactive control apparatus comprises a housing and an interactive control module arranged in the housing;
the interactive control apparatus is independently attached to an interactive device through the housing, and the interactive control apparatus is communicatively connected with an extended reality device through the interactive control module;
the interactive control module is used for processing input instructions executed by users on the interactive device and controlling the extended reality device according to processing results to display the corresponding virtual interactive interface;
each interactive control apparatus is independently attached to one interactive device correspondingly; and each extended reality device is connected with at least one interactive control apparatus.

11. The interactive system as claimed in claim 10, characterized in that: the interactive control module is also used for controlling the interactive device according to the processing results to generate real interactive feedback.

12. The interactive system as claimed in claim 11, characterized in that: the interactive device comprises any one of an electron gun, a dance pad, a golf club, a tennis racket, a badminton racket and an exercise bike.

13. The interactive system as claimed in claim 12, characterized in that: the interactive device is an electron gun, and the electron gun comprises an electron gun body, a chambering module, a heart rate sensor, a loading module, a vibrating motor and a firing button.

14. The interactive system as claimed in claim 11, characterized in that: the extended reality device comprises an augmented reality device, a virtual reality device or a mixed reality device.

15. The interactive system as claimed in claim 10, characterized in that: the interactive control module comprises an input/output interface, a wireless communication module and an MCU;
the MCU is connected with the extended reality device through the wireless communication module, the MCU is connected with the interactive device through the input/output interface, and the MCU realizes data transmission with the interactive device through the input/output interface.

16. The interactive system as claimed in claim 12, characterized in that: the interactive control apparatus also comprises:
a locating module, connected with the interactive control module and configured to locate attitude and position of the interactive device.

17. The interactive system as claimed in claim 13, characterized in that: the locating module comprises an infrared sensor and an inertial measurement unit; and the infrared sensor is used for locating the position of the interactive device, and the inertial measurement unit is used for locating the attitude of the interactive device.

18. The interactive system as claimed in claim 10, characterized in that: the housing is provided with clips and/or adhesive backing and/or magnetic strips; and the housing is attached to the interactive device through the clips and/or adhesive backing and/or magnetic strips.
